(19) United States
(12) Patent Application Publication
(10) Pub. No.: US 2003/0237092 A1
(43) Pub. Date: Dec. 25, 2003

(54) Web page display apparatus

(75) Inventor: Tomoyuki Suzuki, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/338,976

(22) Filed: Jan. 9, 2003

(30) Foreign Application Priority Data
Jun. 19, 2002 (JP) 2002-178586

(51) Int. Cl. H04N 5/445; H04N 7/173

(52) U.S. Cl. 725/40; 725/112

(57) ABSTRACT

The present invention provides a Web page display apparatus including a broadcast for receiving section for receiving a broadcast signal containing broadcast information representing a television broadcast and location information indicating a location of a Web page on an Internet; a first display section for displaying in a first display area on a given display device the television broadcast represented by the broadcast information contained in the broadcast signal received by the broadcast receiving section, a Web-page-information-obtaining section for accessing the Web page the location of which is indicated by the location information contained in the broadcast signal received by the broadcast receiving section to obtain information provided by the Web page is synchronization with the progress of the television broadcast program; and a second display section for displaying the information obtained by the Web-page-information-obtaining section in a second display area on said display device in synchronization with the progress of the television broadcast.

### BACKGROUND OF THE INVENTION

1. Field of the Invention

The present invention relates to a Web page display apparatus for displaying Web page information relating to a television program during receiving the television program.

2. Description of the Related Art

The number of people using the Internet and personal computers has increased in recent years, and along with this increase, more information relating to television programs and commercials has been provided on Web pages and there is increasing need for using personal computers to access Web pages on the Internet to obtain such related information.

For a user to obtain such information under present circumstances, the user memorizes information such as a URL, a product name, or a company name that may be required, or makes a note of such information during watching a television program or commercial. Then, the user uses a device such as a personal computer to access the Internet and directly inputs the URL or uses a search site on the Internet to search for the Web page by using the product name or company name as a search key.

FIG. 21 shows an overview of a system in which URL information is obtained during receiving a television broadcast and Web page information is obtained based on the URL information.

As shown in FIG. 21, a viewer jots down URL information on a memo pad 92, “fujibeer.com” for example, displayed on a television screen during watching a broadcasted television program or commercial. Then, the viewer boots up a personal computer 93 and uses a web browser installed in the personal computer 93 to enter the URL, http:/www.fujibeer.com, based on the URL information that he or she has jotted down on a memo pad 92 to display Web page information on the personal computer 93.

If the viewer cannot directly obtain URL information on the television screen 91 but can obtain related information such as the name of a product or company, he or she may memorize the product or company name or jot it on the memo pad 92. Separately, he or she may boot up the personal computer 93, access an Internet information search site, and search for the Web site based on the product or company name to obtain desired information.

In practice, however, it is difficult for the viewer to accurately memorize or jot down URL information displayed on the television screen 91 and obtain Web page information in a timely manner.

Furthermore, it is troublesome to find URL information based on related information such as a product or company name and then access an appropriate Web page. It is not easy enough for anyone to perform such operations to obtain information in a timely manner.

### SUMMARY OF THE INVENTION

In light of the above circumstances, an object of the present invention is to provide a Web page display apparatus that allows a user to obtain and display Web page information relating to a television program that is being received in synchronization with the progress of the television program without having to perform any special operations.

A first Web page display apparatus of the present invention that achieves the above-described object comprises a broadcast receiving section receiving a broadcast signal containing broadcast information representing a television broadcast and location information indicating the location of a Web page on the Internet; a first display section displaying the television broadcast represented by the broadcast information contained in the broadcast signal received by the broadcast receiving section in a first display area on a given display device; a Web-page-information-obtaining section extracting the location information contained in the broadcast signal received by the broadcast receiving section and, upon being triggered by the extraction of the location information, accessing a homepage the location of which is indicated by the location information to obtain information provided by the Web page in synchronization with the progress of the television broadcast; and a second display section displaying the information obtained by the Web-page-information-obtaining section in a second display area on the display device in synchronization with the progress of the television broadcast.

The first Web page display apparatus of the present invention can automatically obtain Web page information relating to the content of a broadcast received and display the information on the same screen on which the received broad cast is being displayed, in synchronization with the progress of the television broadcast without requiring any extra operations by a viewer if a broadcasting station embeds in advance information about the location of the Web page in a broadcast signal.

A second Web page display apparatus according to the present invention that achieves the above-described object comprises an image-receiving section receiving an image signal representing image of a television broadcast;

a character recognition section analyzing the image represented by the image signal received by the image receiving section to recognize a character string contained in the image; a Web-page-information-obtaining section triggered by recognition of a location character string by the character recognition section to access a Web page the location of which is indicated by the location character string to obtain information provided by the Web page in synchronization with the progress of the television broadcast if the character string recognized by the character recognition section is the location character string indicating the location of the Web page on the Internet; and a display section displaying the information obtained by the Web-page-information-obtaining section in synchronization with the progress of the television broadcast.

The second Web page display apparatus of the present embodiment can automatically obtain Web page information relating to the content of a television broadcast being received and display the information on a screen in synchronization with the progress of the television broad cast without requiring any extra processes or operations by a broadcasting station or a viewer.

Preferably, the second Web page display apparatus comprises a search section searching the Internet for a Web page based on a character string recognized by the character recognition section; wherein if the Web page is found by the search section, the Web-page-information-obtaining section is triggered by the finding of the Web page to accesses the Web page to obtain information provided by the Web page in synchronization with the progress of the television broadcast.

Configured as described above, the second Web page display apparatus of the present invention can find a Web page based on a company name or product name to display information provided by the Web page in synchronization of the progress of a television broadcast even if the image of the broadcast does not contain URL information.

A third Web page display apparatus of the present invention that achieves the above-described object comprises a sound-receiving section receiving a sound signal representing sound of a television broadcast;

a speech recognition section analyzing the sound represented by the sound signal received by the sound receiving section to recognize a word contained in the sound; a Web-page-information-obtaining section accessing a Web page the location of which is indicated by the location word to obtain information provided by the Web page in synchronization with the progress of the television broadcast if the word recognized by the speech recognition section is the location word indicating the location of the Web page on the Internet, the access being triggered by the recognition of the location word; and a display section for displaying the information obtained by the Web-page-information-obtaining section in synchronization with the progress of the television broadcast.

The third Web page display apparatus of the present invention can automatically obtain Web page information relating to the content of a television broad cast being received and display it on a screen in synchronization with the progress of the television broadcast without requiring any extra operations performed by a broadcasting station or a viewer.

The third Web page display apparatus preferably comprises a search section searching the Internet for a Web page based on a word recognized by the speech recognition section, wherein; if the Web page is found by the search section, the Web-page-information-obtaining section is triggered by the finding of the Web page to access the Web page to obtain information provided by the Web page in synchronization with the progress of the television broadcast.

Configured as described above, the third Web page display apparatus of the present invention can find a Web page based on a company name or product name to display information provided by the Web page in synchronization with the progress of the television broadcast even if the sound of the broadcast does not contain URL information and the like.

### BRIEF DESCRIPTION OF THE DRAWINGS

FIG. 1 shows a general configuration of a Web page display apparatus according to a first embodiment of the present invention;

FIG. 2 shows a general view of a computer system including the Web page display apparatus according to the first embodiment;

FIG. 3 shows a configuration of a hardware of the computer system shown in FIG. 2;

FIG. 4 shows URL information collected by a broadcasting station according to the first embodiment;

FIG. 5 shows a format of location information contained in a broadcast signal according to the first embodiment;

FIG. 6 shows how the location information is sent from the broadcasting station according to the first embodiment;

FIG. 7 shows how the URL information is obtained from a received television broadcast signal according to the first embodiment;

FIG. 8 shows a flowchart of a process performed in the Web page display apparatus according to the first embodiment;

FIG. 9 shows a data structure of a URL database used in the embodiment;

FIG. 10 shows a general configuration of a Web page display apparatus according to a second embodiment of the present invention;

FIG. 11 shows a computer system including the Web page display apparatus according to the second embodiment;

FIG. 12 shows a flowchart of a process performed in the Web page display apparatus according to the second embodiment;

FIG. 13 shows a general configuration of a Web page display apparatus according to a third embodiment of the present invention;

FIG. 14 shows a flowchart of a process performed in the Web page display apparatus according to the third embodiment;

FIG. 15 shows a general configuration of a Web page display apparatus according to a fourth embodiment of the present invention;

FIG. 16 shows a flowchart of a process performed in the Web page display apparatus according to the fourth embodiment;

FIG. 17 shows a general configuration of a Web page display apparatus according to a fifth embodiment of the present invention;

FIG. 18 shows a flowchart of a process performed in the Web page display apparatus according to the fifth embodiment;

FIG. 19 shows a setting panel for Web page display;

FIG. 20 shows a Web page URL recording programming panel; and

FIG. 21 shows a system for obtaining URL information during receiving a television broadcast and obtaining Web page information based on the URL information according to the related art.

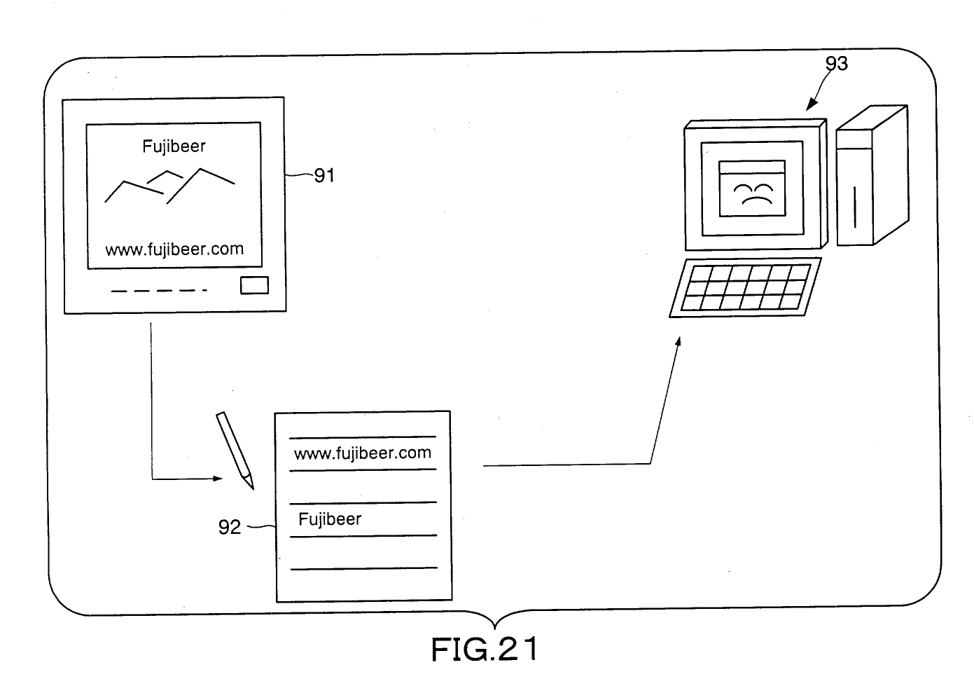

### DETAILED DESCRIPTION OF THE PREFERRED EMBODIMENTS

Embodiments of the present invention will be described below.

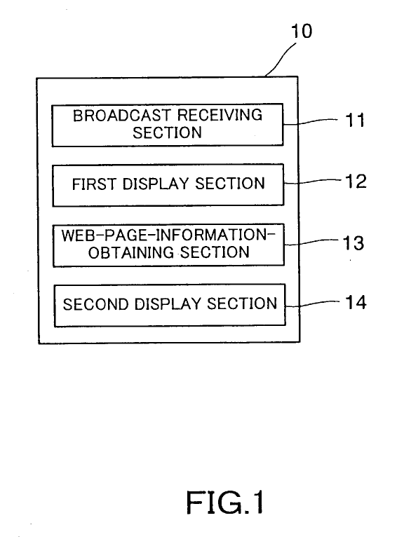

FIG. 1 schematically shows a general configuration of a Web page display apparatus according to a first embodiment of the present invention.

The first embodiment is an example of the first Web page display apparatus of the present invention.

As shown in FIG. 1, the Web page display apparatus 10 of the first embodiment comprises a broadcast receiving section 11, a first display section 12, a Web-page-information-obtaining section 13, and a second display section 14.

The broadcast receiving section 11 receives broadcast signals containing broadcast information representing television broadcasts and location information indicating the Web page locations. The first display section 12 displays the television broadcasts represented by the broadcast information contained in the broadcast signals received by the broadcast receiving section 11 on a first display area 12a on a given display device. The Web-page-information-obtaining section 13 extracts the location information contained in the broadcast signals received by the broadcast receiving section 11, is triggered by the extraction of the location information to access the Web page the location of which is indicated by the location information, and obtains information provided by the Web page in synchronization with the progress of the television program. The second display section 14 displays information obtained by the Web-page-information-obtaining section 13 on a second display area 12b on the above described display device in synchronization with the progress of the television program.

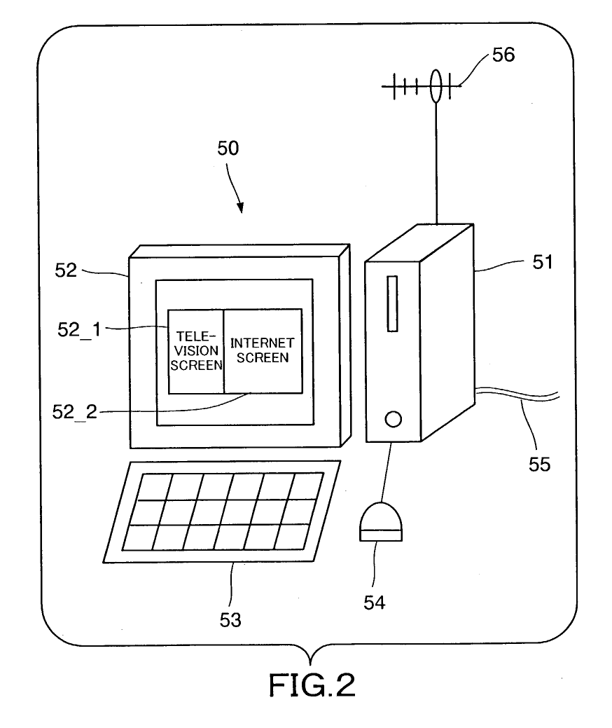

FIG. 2 shows an overview of a computer system including the Web page display apparatus according to the first embodiment.

The computer system 50 shown in FIG. 2 comprises a computer system unit 51 containing a television tuner, a display device 52 that can display Web page information in synchronization with a television program, a keyboard 53 for inputting required commands into the computer system unit 51, a infrared commander 54 for providing a command indicating a channel for receiving a television broadcast and other commands, a communication line 55 for connecting the computer system unit 51 to the Internet, and a television antenna 56 for receiving television broadcasts.

Provided in the computer system unit 51 are the broadcast receiving section 11, first display section 12, a Web-page-information-obtaining section 13, and second display section 14 shown in FIG. 2.

A web browser for the Web page is installed in the information-receiving section 13 for browsing Web pages on the Internet based on URL information. Also provided in the Web-page-information-obtaining section 13 is a URL database storing URL information obtained by the Web-page-information-obtaining section 13. The data structure of the URL database will be described later.

In the first embodiment, for example, a television broadcasting station includes in a television program or commercial the URL information of a Web page relating to a television program or commercial display in synchronization with the display during a vertical retrace interval of a broadcast signal and broadcasts it.

In the Web page display apparatus, the broadcast receiving section 11 provided in the computer system 50 (see FIG. 2) receives the broadcast signal containing the broadcast information representing the television broadcast and the location information indicating the location of the Web page and first display section 12 displays the television broadcast represented by the broadcast information contained in the broadcast signal received by the broadcast receiving section 11 in a first display area 52_1 of the display device 52. At the same time, the Web-page-information-obtaining section 13 accesses the Web page the location of which is indicated by the URL information, that is, the location information as referred to herein, contained in the broadcast signal received by the broadcast receiving section 11 to obtain information provided by the Web page in synchronization with the progress of the television broadcast program. The second display section 14 displays the information obtained by the Web-page-information-obtaining section 13 in a second display area 52_2 of the display device 52 in synchronization with the progress of the television broadcast program.

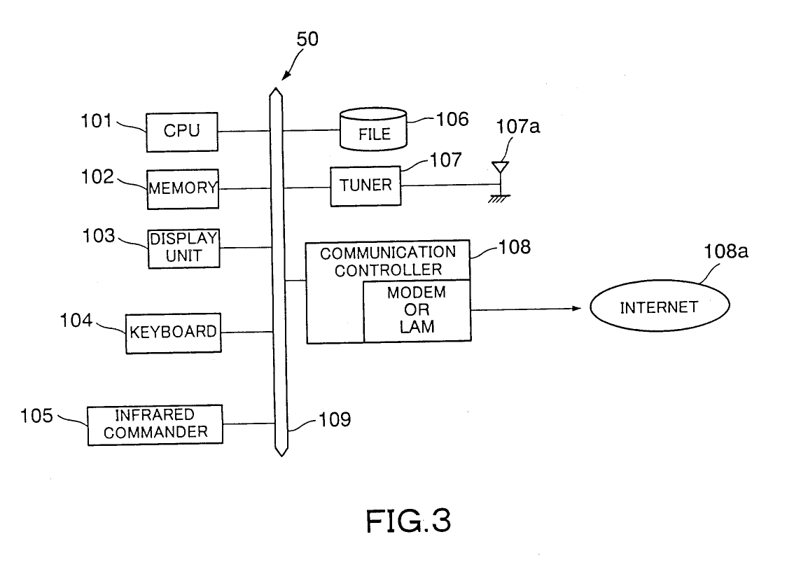

FIG. 3 shows a configuration of the hardware of the computer system shown in FIG. 2.

As shown in FIG. 3, the computer system 50 comprises a Central Processing Unit (CPU) 101, memory 102, a display unit 103, a keyboard 104, an infrared commander 105, a file 106, a television tuner 107, a communication controller 108, and a bus 109 interconnecting these components.

A television antenna 107a is connected to the television tuner 107. The communication controller 108 is connected to the Internet 108a through a modem or LAN.

Hardware components such as the CPU 101, memory 102, keyboard 104, infrared commander 105, file 106, television tuner 107, and communication controller 108, shown in FIG. 3 form the components of the Web page display apparatus 10 shown in FIG. 1.

A process performed in a television broadcasting station according to the first embodiment will be detailed below.

In the television broadcasting station, an information processing device such as a personal computer is used to search the Internet for a Web page with reference to a television program schedule or a commercial timetable and collect URL information to be contained in a broadcast signal of a television program or commercial.

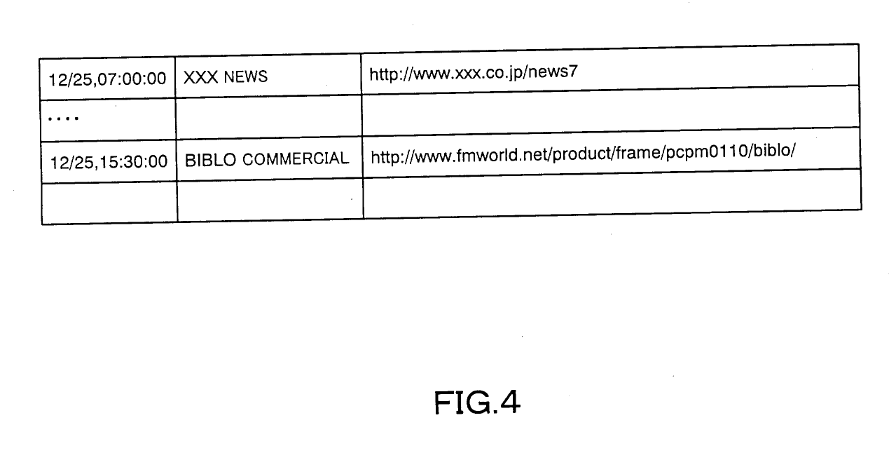

FIG. 4 shows URL information collected in the television broadcasting station according to the first embodiment.

For example, URL information, “http://www.xxx.co.jp/news7”, is obtained for a news program XXX to be broadcasted from 7:00 on December 25 from XXX television station, and URL information “http://www.fmworld.net/product/frame/pcpm0110/biblo/” is obtained for a BIBLO commercial to be broadcasted from 15:30 on December 26, as shown in FIG. 4. The URL information thus obtained can be embedded in the vertical retrace interval of the leading part from where the send signal of the program or commercial is starting to construct a broadcast signal containing broadcast information representing the television broadcast and location information indicating the location of the Web page on the Internet.

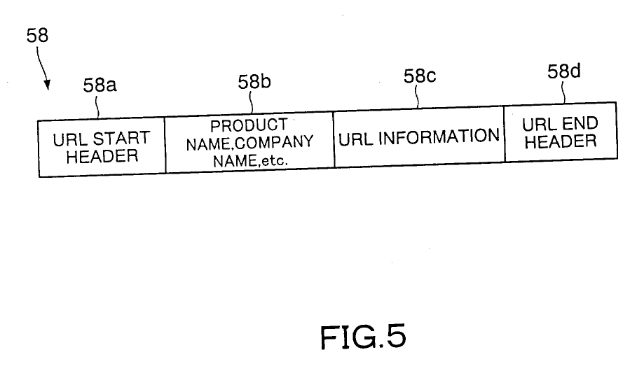

FIG. 5 shows the format of location information contained in a broadcast signal according to the first embodiment.

As shown in FIG. 5, a URL start header 58a indicating the start of the URL information is provided at the leading part of the location information 58 and a URL end footer 58d indicating the end of the URL information is provided at the trailing part of the location information 58d. Related information such as a product name and/or company name and the URL information 58c is provided between them.

The location information 58 is sent over airwaves. There is a possibility that the location information 58 may be dropped off and cannot be received surely by a receiver depending on conditions of the airwaves. Therefore, a plurality of pieces of the same location information are sent in vertical retrace intervals of an image signal to improve the accuracy of URL detection in the receiver.

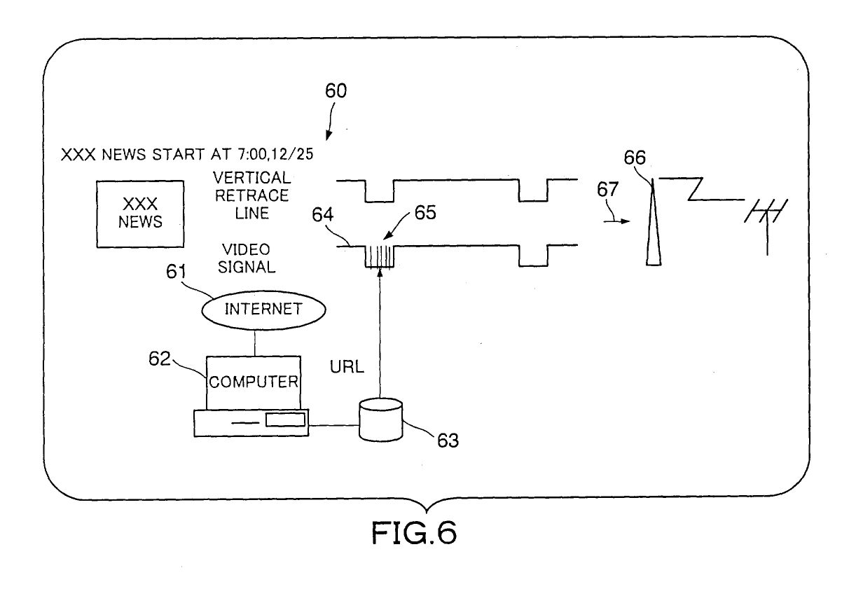

FIG. 6 shows how the location information is sent from the television station according to the first embodiment.

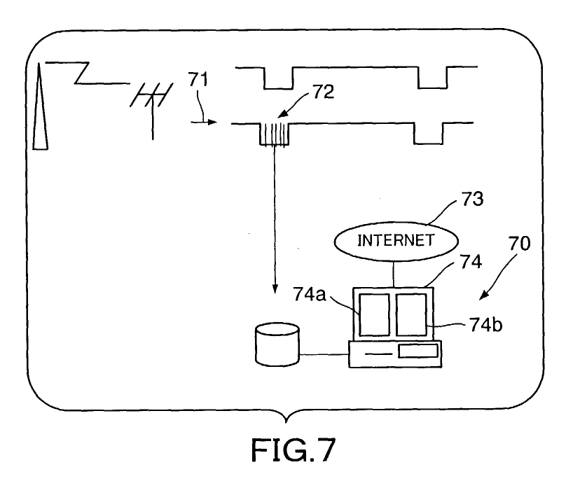

When XXX news program at 7:00 on December 25 is broadcasted from the television broadcasting station 60 as shown in FIG. 6, location information 58 including URL information, for example, http://www.xxx.co.jp/news 7 shown in FIG. 7, which is obtained by using a computer system 62 to search the Internet 61 for a Web page, collected and stored in the file 63, is embedded in a vertical retrace interval 65 of a video signal 64. Then the broadcast signal 67 in which the information is embedded is sent through a transmitting antenna 66.

FIG. 7 shows how URL information is obtained from a received television broadcast signal according to the first embodiment.

As shown in FIG. 7, the broadcast signal sent from the television station is received by a Web page display apparatus 70 of the present embodiment. URL information is extracted from location information embedded in a vertical retrace interval 72 of an image signal 71 and the URL information is used to access a Web page on the Internet 73 and obtain Web page information provided by the Web page. The obtained Web page information 74b is displayed on a display device 74 along with a television broadcast 74a.

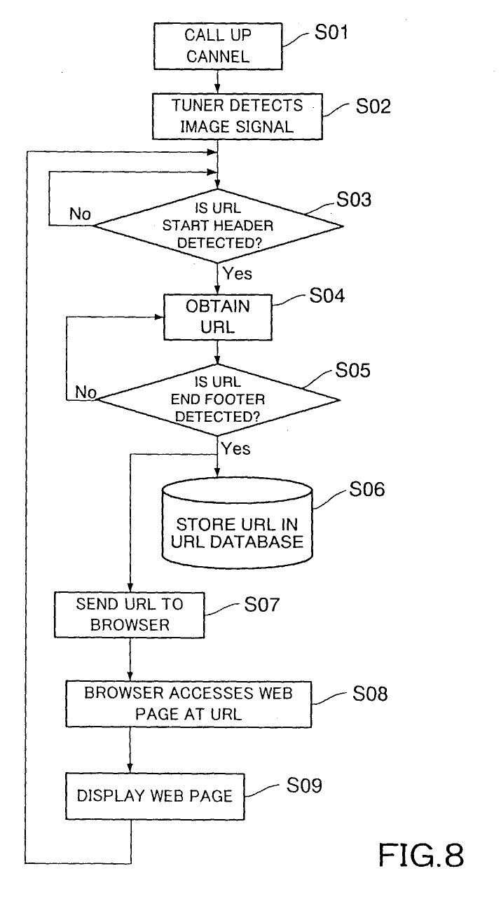

FIG. 8 shows a flowchart of a process performed in the Web page display apparatus according to the first embodiment.

A user of the Web page display apparatus 50 (see FIG. 2) operates an infrared commander 54 to call up a channel (step S01), as shown in FIG. 8. Then, the tuner (broadcast receiving section 11 (see FIG. 1)) contained in the computer system unit 51 detects an image signal of a television broadcast (step S02). The first display section 12 (see FIG. 1) displays on the first display area 52_1 of the display device (see FIG. 2) the television broadcast received by the broadcast receiving section 11.

Then the Web-page-information-obtaining section 13 (see FIG. 1) detects a URL start header in location information embedded in a vertical retrace interval of the image signal (step S03). The location information consists of the URL start header 58a, related information 58b such as a product name or company name, URL information 58c, and URL end footer 58d, as shown in FIG. 5.

After the URL header is detected, URL information is obtained (step S04).

When the URL end footer 58d is detected (step S05), the related information 58b such as the product name or company name and the URL information 58c, which are the body of the location information, are extracted and stored in the URL database provided in the computer system unit 51 (see FIG. 2) (step S06).

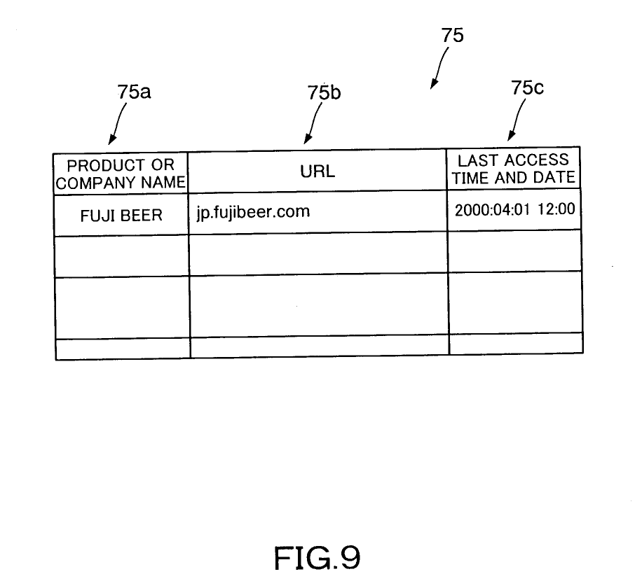

FIG. 9 shows a data structure of the URL database used in the present embodiment.

The URL database is provided in the file 106 shown in FIG. 3.

As shown in FIG. 9, the URL database 75 stores information 75a such as product names or company names, “Fuji Beer” for example, URLs 75b such as “jp.fujibeer.com” for example, and last access time and date 75c such as “2002:04:01 12:00.”

The URL information extracted at step S05 is stored in the URL database 75 at step S06. If a commercial is repeatedly broadcasted during a short time period and Web page information about the commercial were displayed each time the commercial is broadcasted, it would bother viewers. Therefore, if the last access time and date 75c shows that a commercial has been displayed quite recently, step S07 and the subsequent steps may be skipped and the process may return to step S03, thereby aborting the display of the Web page information.

After the URL end footer is detected at step S05 in FIG. 8, the URL information is sent to a Web browser installed in the Web-page-information-obtaining section 13 (see FIG. 1) (step S07). The Web browser accesses the Web page at the URL (step S08) to obtain Web page information.

The second display section 14 (see FIG. 1) displays the Web page information in the second display area 52_2 (see FIG. 2) in synchronization with the progress of the television program (step S09).

As described above, the television broadcasting station embeds the URL of a Web page relating to a television program or commercial in a vertical retrace interval of a television broadcast image signal, for example, and broadcasts it in synchronization with the display of television program of commercial. The broadcast receiving section 11 and Web-page-information-obtaining section 13 of Web page display apparatus 10 (see FIG. 1) included in the computer system 50 (see FIG. 2) of the viewer obtain the URL information and accesses the Internet to obtain the Web page information. The first display section 12 displays the television broadcast information in the first display area 52_1 of the display device 52 (see FIG. 2) and the second display section 14 displays the Web page information in the second display area 52_2 of the display device 52 (see FIG. 2).

Thus, the Web page display apparatus according to the first embodiment allows the user to view Internet Web page information on the same screen on which a television program or commercial is displayed without having to perform any extra operation for searching for URL information or accessing the Web page.

While the example of the first embodiment has been provided in which location information indicating the location of a Web page is embedded in a vertical retrace interval of an image signal, the position in which the location information is embedded is not limited to it. The location information may embedded in any position of an image signal from which the location information can be extracted.

The location information as referred to herein is not limited to URL information. It may any information that indicates the location of a Web page.

A second embodiment of the present invention will be described below.

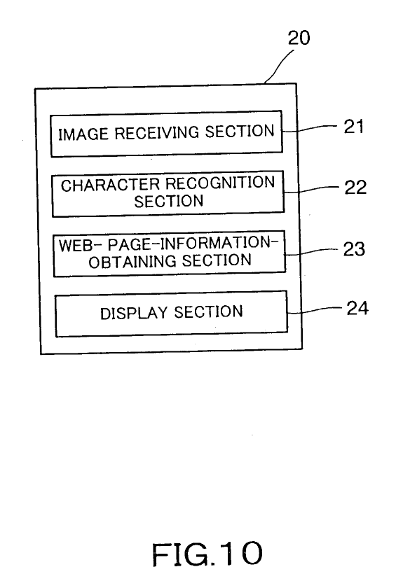

FIG. 10 schematically shows a configuration of a Web page display apparatus according to the second embodiment.

The second embodiment is an example of the second Web page display apparatus of the present invention.

As shown in FIG. 10, the Web page display apparatus 20 of the second embodiment comprises an image receiving section 21, a character recognition section 22, a Web-page-information-obtaining section 23, and a display section 24.

The image-receiving section 21 receives image signals representing television broadcast images. The character recognition section 22 analyzes the images represented by the vide signals received by the image receiving section 21 to recognize a character strings included in the images. If the character string recognized by the character recognition section 22 is a location character string representing the location of a Web page on the Internet, the recognition of the location character string triggers the Web page information obtaining means 23 to access the Web page at the location indicated by the location character string and obtain information provided by the Web page in synchronization with the progress of the television broadcast. The display section 24 displays the information obtained by the Web-page-information-obtaining section 23 in synchronization with the progress of the television broadcast.

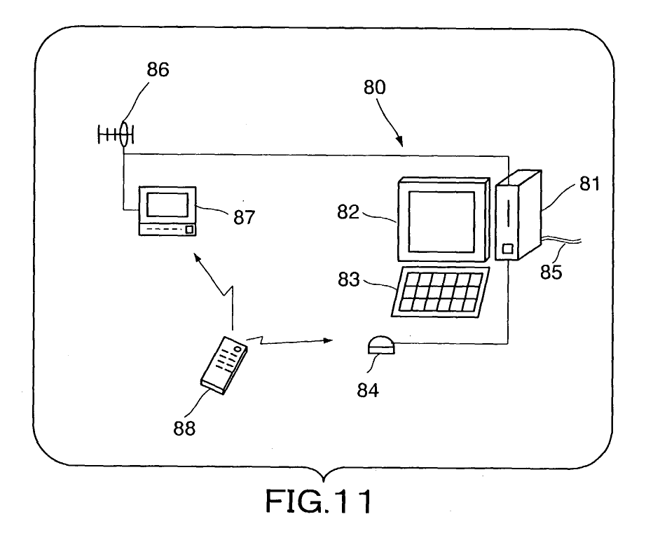

FIG. 11 shows an overview of a computer system including the Web page display apparatus according to the second embodiment.

The computer system 80 shown in FIG. 11 comprises a computer system unit 81 containing a television tuner, a display device 82 for displaying Internet Web pages, a keyboard 83 for inputting required commands in the computer system unit 81, an infrared commander 84 for providing a command for providing a command indicating a channel for receiving a television broadcast and other commands, a communication line 85 for connecting the computer system unit 81 to the Internet, and a television antenna 86 for receiving television broadcasts.

Provided in the computer system unit 81 are an image receiving section 21, character recognition section 22, and Web-page-information-obtaining section 23 shown in FIG. 10. A display section 24 is provided in the display device 82.

A Web browser for browsing a Web page based on the URL information is installed in the Web-page-information-obtaining section 23. Also, a URL database for storing URL information obtained by the Web-page-information-obtaining section 23 is provided in the Web-page-information-obtaining section 23.

FIG. 11 shows the embodiment in which Web page information is displayed in the display screen of the display device 82 of the computer system 80 while a television broadcast is being received by using television receiver 87 and a remote controller 88 provided separately from the computer system 80. However, the broadcast and Web page information may be simultaneously on the screen of the display device 82 of the computer system unit 81, rather than providing the separate television receiver 87, which is not separated from the computer system 80.

The configuration of hardware of the computer system 80 shown in FIG. 11 is the same as that of the computer system shown in FIG. 3.

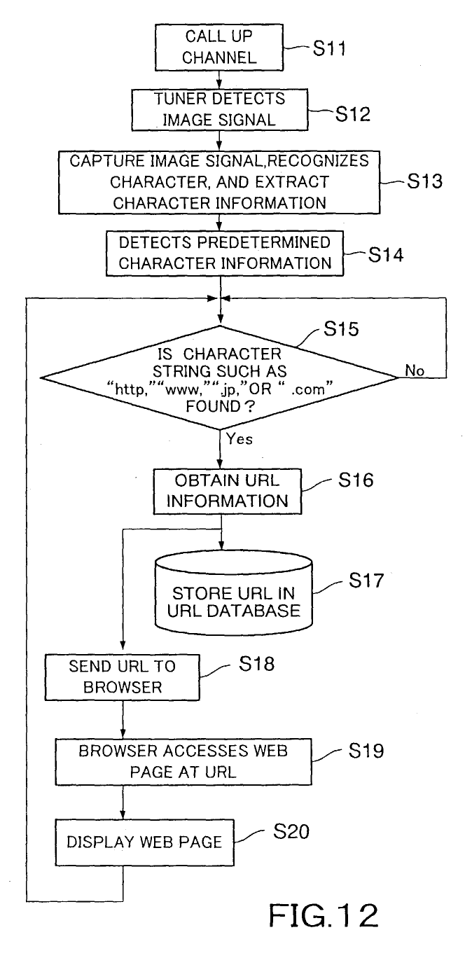

FIG. 12 shows a flowchart of a process performed in the Web page display apparatus according to the second embodiment.

As shown in FIG. 12, when a user of the Web page display apparatus 80(see FIG. 11) and the television receiver 87 operates the remote controller 88 or the infrared commander 84 or the like to call up a receiving channel (step S11), the television receiver 87 displays information broadcasted over the channel on the screen. At the same time, the image-receiving section 21 (see FIG. 10) contained in the compute system unit 81 detects an image signal of the television broadcast (step S12).

The character recognition section 22 (see FIG. 10) captures the detected image signal and performs a character recognition operation to extract character information (step S13). Then, predetermined character information is detected (step S14).

The predetermined character information may be character strings, such as “http,” “www,” “jp,” or “.com” that are often used in URLs.

If the predetermined character information is detected at step S15, the process proceeds to step S16. On the other hand, if the predetermined character information is not detected at step S15, the operation for detecting it is repeated.

At step S16, URL information is extracted through character recognition from the information captured at step S13 and stored in a URL database provided in the computer system unit 81 (see FIG. 11) (step S17) and also sent to the browser installed in the Web-page-information-obtaining section 23 (see FIG. 10) (step S18). The Web browser accesses a Web page based on the URL information (step S19) to obtain Web page information. The display section 24 displays the Web page information on the screen of the display device in synchronization of the progress of the television program (step S20). Then, the process returns to step S15 and the operation for detecting the predetermined character information is repeated.

In this way, the user can view Web page information while watching a television program without having to perform any extra operation for searching for URL information or accessing the Web page.

A third embodiment of the present invention will be described below.

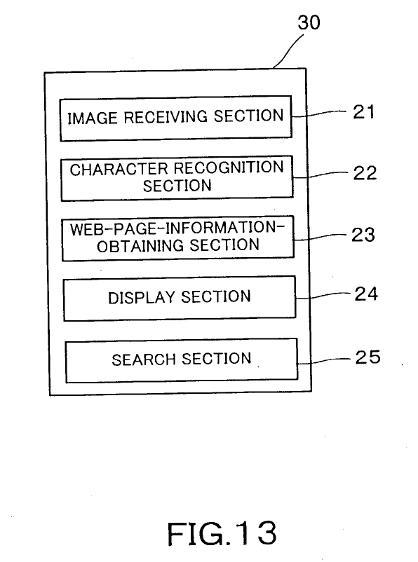

FIG. 13 schematically shows a configuration of a Web page display apparatus according to the third embodiment.

The third embodiment is a variation of the second embodiment of the present invention. The Web page display apparatus of the third embodiment is configured by adding a search section 25 to the Web page display apparatus of the second embodiment that searches the Internet for a Web page based on a character string recognized by a character recognition section 22. A Web-page-information-obtaining section 23 accesses the Web page found by the search section 25 to obtain information provided by the Web page in synchronization with the progress of a television program.

As shown in FIG. 13, the Web page display apparatus 30 of the third embodiment comprises an image receiving section 21, a character recognition section 22, a Web-page-information-obtaining section 23, a display section 24, and a search section 25.

The hardware configuration of the third embodiment is the same as that of the computer system shown in FIG. 11.

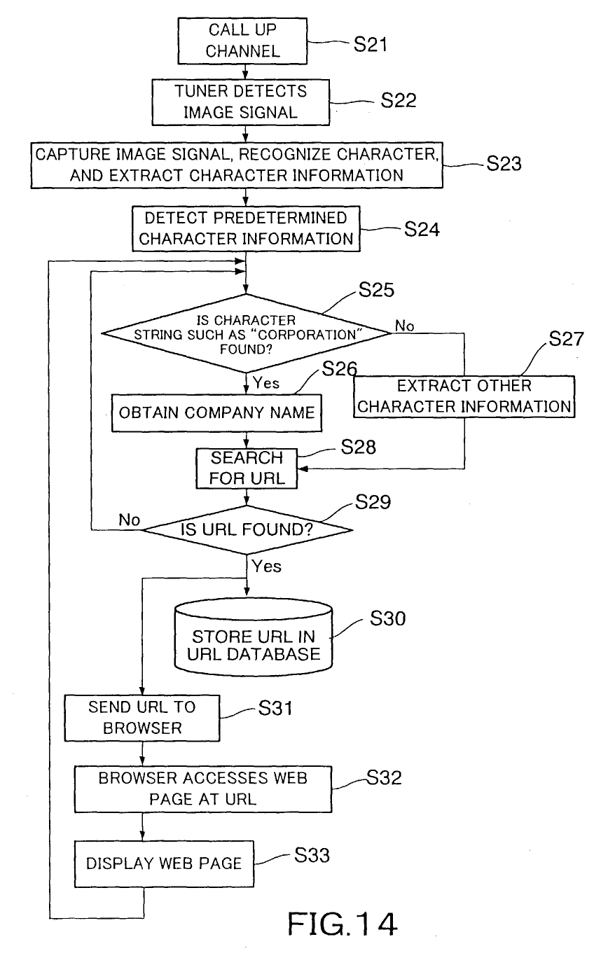

FIG. 14 shows a flowchart of a process performed in the Web page display apparatus according to the third embodiment.

A user of the Web page display apparatus 80 and a television receiver 87 (see FIG. 11) operates a remote controller 88 or infrared commander 84 to call up a receiving channel (step S21) as shown in FIG. 14. As a result, the television receiver 87 displays information broadcasted over the channel on the screen. Then, the image-receiving section 21 (see FIG. 13) contained in a computer system unit 81 detects an image signal of the television broadcast (step S22).

The character recognition section 22 (see FIG. 13) captures the detected image signal and performs a character recognition operation to extract character information (step S23). Then, predetermined character information is detected (step S24).

The predetermined character information may be character strings such as “Corporation” and “Co.” that are often used in company names.

If the predetermined character information is detected at step S25, the process proceeds to step S26. On the other hand, if the predetermined information is not detected, the process proceeds to step S27.

At step S26, a company name is obtained based on the detected predetermined character information. Then, the process proceeds to step S28.

At step S27, on the other hand, character information other than the predetermined character information is extracted. If the broadcast is stereophonic, for example, then it is likely to be a commercial which expresses a product name. Therefore a character string that is likely to be a product name is extracted from the character information extracted at step S23. Then, the process proceeds to step S28.

At step S28, a URL database 75 (see FIG. 9) formed in the computer system unit 81 (see FIG. 11) is searched for URL information that corresponds to the company name obtained at step S26 or the product name obtained at step S27. If such URL information is not found, an Internet search site or the like, to detect whether the URL information corresponding to the URL database 75 exists or not is used to search for the URL information (step S28). If the URL information is found (step S29), then the process proceeds to step S30, where the URL information retrieved is stored in the URL database and also sent to a Web browser installed in the Web-page-information-obtaining section 23 (see FIG. 13) (step S31). The web browser access a Web page based on the URL information to obtain Web page information (step S32). The display section 24 displays the Web page information on the screen of a display device in synchronization with the progress of the television program (step S33). Then the process returns to step S25 and the operation for searching for predetermined character information is repeated.

Thus, the Web page display apparatus according to the third embodiment allows the user to view Web page information simultaneously with watching a television program without having to perform any extra operation for searching for URL information or accessing the Web page.

A fourth embodiment of the present invention will be described below.

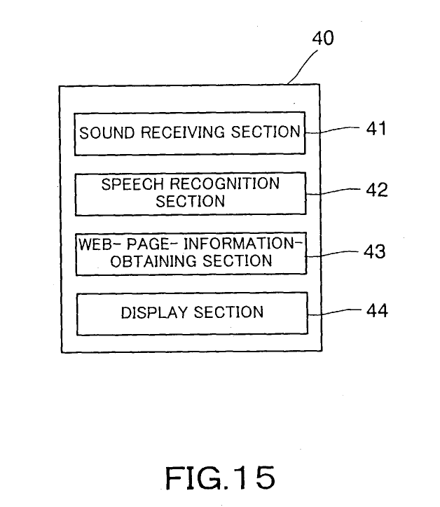

FIG. 15 shows a Web page display apparatus according to the fourth embodiment.

The fourth embodiment represents an example of the third Web page display apparatus of the present invention.

As shown in FIG. 15, the Web page display apparatus 40 of the fourth embodiment comprises a sound receiving section 41, a speech recognition section 42, a Web-page-information-obtaining section 43, and a display section 44.

The sound-receiving section 41 receives sound signals representing sound of a television broadcast. The speech recognition section 42 analyzes sound signals received by the sound-receiving section 41 to recognizes a word contained in the sound. If the word recognized by the speech recognition section 42 is a location word indicates the location of a Web page on the Internet, the recognition triggers the Web page information obtaining means 43 to access the Web page indicated by the location word to obtain information provided by the Web page in synchronization with the progress of the television broadcast program. The display section 44 displays the information obtained by the Web page information obtaining means 43 in synchronization with the progress of the television program.

The configuration of the hardware of the fourth embodiment is the same as that of the computer system shown in FIG. 11.

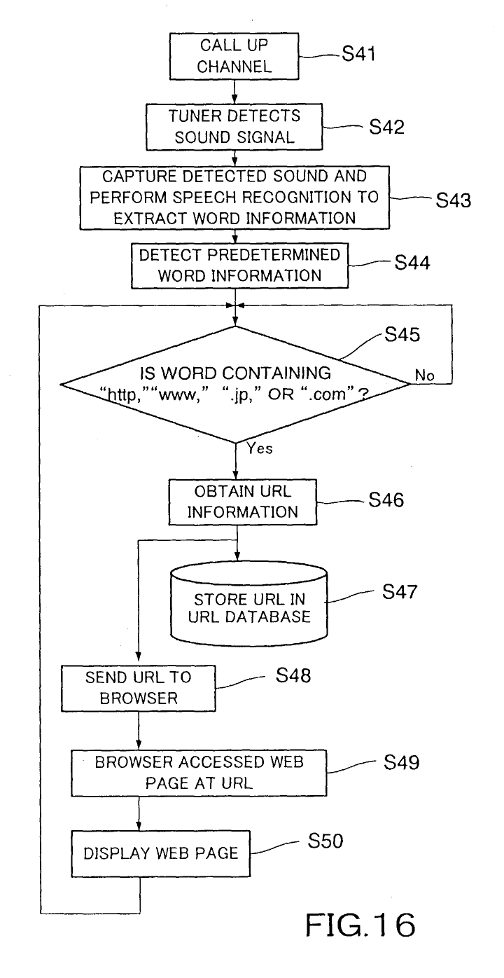

FIG. 16 is a flowchart showing a process performed by the Web page display apparatus according to the fourth embodiment.

A user of the Web page display apparatus 80 (see FIG. 11) and a television receiver 87 operates a remote controller 88 and an infrared commander 84 to call up a receiving channel (step S41) as shown in FIG. 16. Then, the television receiver 87 displays information broadcasted over the receiving channel on the display screen. At the same time, the sound-receiving section 41 (see FIG. 15) contained in the computer system unit 81 detects a sound signal in the television broadcast (step S42).

The speech recognition section 42 (see FIG. 15) captures the detected sound signal and performs a speech recognition process to extract word information (step S43). Then a predetermined word is detected (step S44).

The predetermined word information may be the sound of a character string that is often used in URLs, such as “http,” “www,” “jp,” and “.com.”

A process at step S45 and the subsequent steps is the same as the flowchart in the third embodiment described in view of FIG. 14, and therefore the description of which will be omitted.

Thus, the Web page display apparatus according to the fourth embodiment allows the user to view Internet Web page information while watching a television program without having to perform any special operations for searching for URL information and accessing the Internet Web page.

A fifth embodiment of the present invention will be described below.

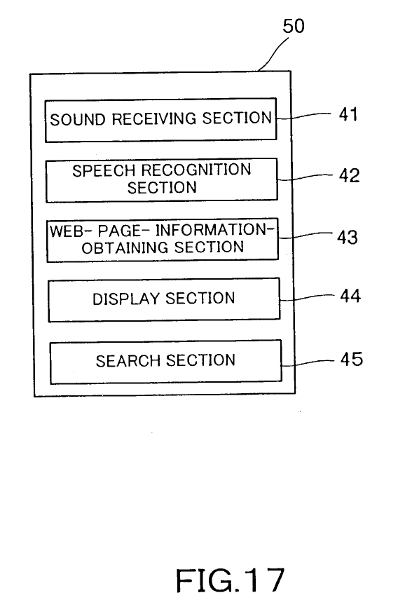

FIG. 17 schematically shows a Web page display apparatus according to the fifth embodiment.

The fifth embodiment is a variation of the fourth embodiment of the present invention. The Web page display apparatus of the fifth embodiment is formed by adding a search section 45 to the Web page display apparatus of the fourth embodiment that searches the Internet for a Web page based on a word recognized by a speech recognition section 42. A Web-page-information-obtaining section 43 accesses the Web page found by the search section 45 to obtain information provided by the Web page in synchronization with the progress of a television broadcast program.

As shown in FIG. 17, the Web page display apparatus 50 of the fifth embodiment comprises a sound receiving section 41, a speech recognition section 42, a Web-page-information-obtaining section 43, a display section 44, and a search section 45.

The configuration of the hardware of the fifth embodiment is the same as that of the computer system shown in FIG. 11.

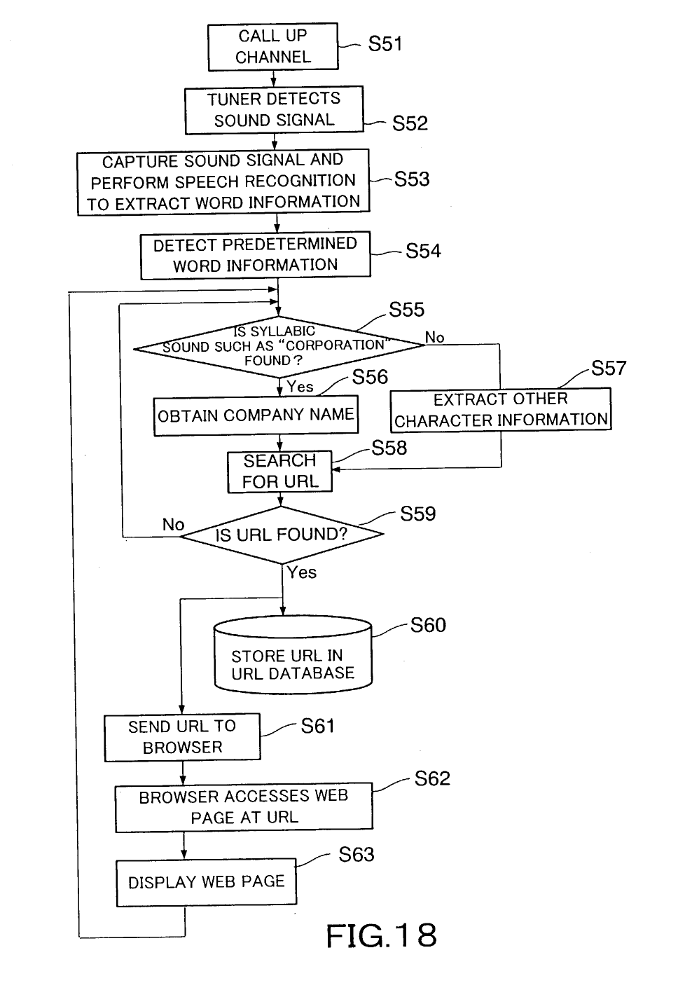

FIG. 18 shows a flowchart of a process performed in the Web page display apparatus according to the fifth embodiment.

A user of the Web page display apparatus 80 and a television receiver 87 (see FIG. 11) operates a remote controller 88 or an infrared commander 84 or the like, to call up a receiving channel (step S51) as shown in FIG. 18. Then, the television receiver 87 displays information broadcasted over the channel on its screen. At the same time, the sound receiving section 41 (see FIG. 17) contained in the computer system unit 81 detects a sound signal of the television broadcast (step S52).

The speech recognition section 42 (see FIG. 17) captures the detected sound signal and performs a speech recognition process to extract a word (step S50). Then predetermined word information is detected (step S54).

The predetermined word information may be the syllabic sound of a character string, such as “corporation” or “Co.”, that is often used in a company name.

A process at step S55 and the subsequent steps is the same as the flowchart in the fourth embodiment described in view of FIG. 16, and therefore the description of which will be omitted.

Thus, the Web page display apparatus according to the fifth embodiment allows the user to view Internet Web page information while watching a television program without having to perform any special operations for searching URL information and accessing the Web page.

In the above description of the each embodiment, the Web page display apparatuses have been described that use one of the three URL information detecting methods: the method of detecting URL information embedded in a vertical retrace interval of a broadcast signal in advance, the method of capturing an image signal and extracting URL information contained in it, and the method of capturing a sound signal and extracting URL information contained in it. However, a Web page display apparatus can be configured so as to be capable of performing a plurality of URL information detecting methods and allowing a user to select a desired method from among the plurality of the detecting methods.

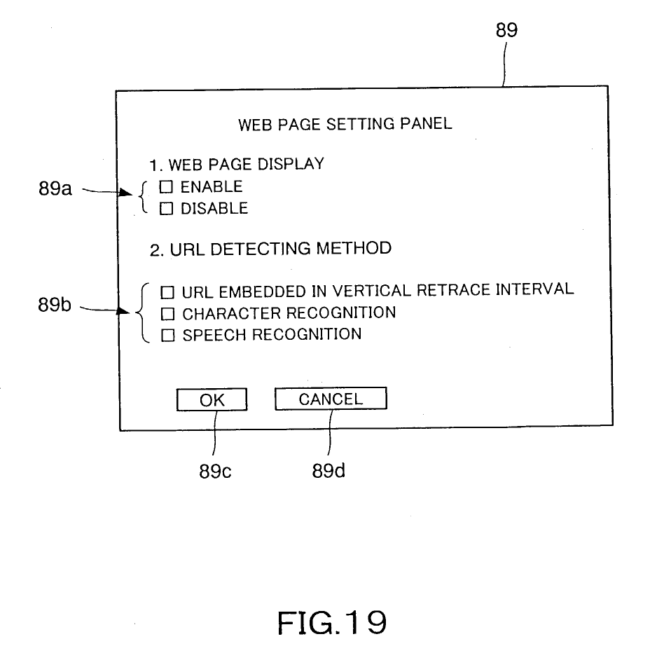

FIG. 19 shows a setting panel for Web page display.

As shown in FIG. 19, the Web page display setting panel 89 includes buttons 89a for enabling or disabling Web page display, buttons 89b for selecting one of the three URL information detecting methods, an OK button 89c, and a Cancel button 89d.

The page display apparatus of the present invention configured so as to be capable of using any of a plurality of detecting information to found URL information allows a user to select a desired URL information detecting method from among them by using the Web page display setting panel 89 shown in FIG. 19.

Furthermore, Web page URL recording programming capability similar to image recording programming capability may be added to a Web page display apparatus of the present invention to automatically collect and store URL information during receiving television broadcasts.

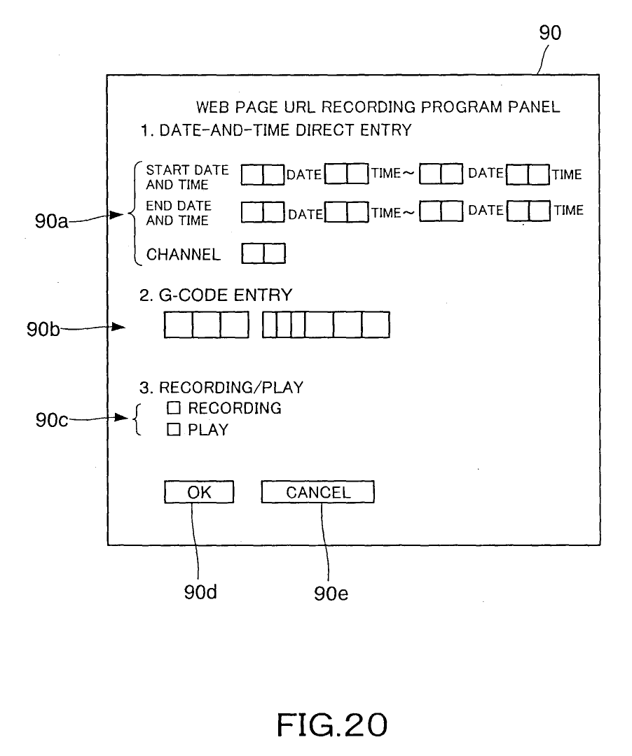

FIG. 20 shows a Web page URL recording programming panel.

As shown in FIG. 20, the Web page URL recording programming panel 90 includes a date-and-time direct entry field 90a for entering a recording start date and time, a recording end date and time, and a channel, a G-code entry field 90b, a record and play selection field 90c, an OK button 90d, and a cancel button 90e.

A user uses the Web page URL recording programming panel 90 provided in the Web page display apparatus including Web page URL recording programming capability to direct the Web page display apparatus to record/play a television program at a desired date and time. The Web page display apparatus receives the specifications and automatically collects URLs and stores them in a URL database or the like. When the user later directs the apparatus to play the program, the apparatus sequentially displays Web page information based on the URLs stored in the URL database.

Thus, according to the present invention, a Web page display apparatus can be implemented that can display Web page information relating to the content of a television broadcast in synchronization with the progress of the television broadcast program without any special operations being performed by the user.

What is claimed is:

1. A Web page display apparatus comprising:
a broadcast receiving section receiving a broadcast signal containing broadcast information representing a television broadcast and location information indicating a location of a Web page on the Internet;
a first display section displaying the television broadcast represented by the broadcast information contained in the broadcast signal received by said broadcast receiving section in a first display area on a given display device;
a Web-page-information-obtaining section extracting the location information contained in the broadcast signal received by said broadcast receiving section and, upon being triggered by the extraction of said location information, accessing a homepage the location of which is indicated by said location information to obtain information provided by said Web page in synchronization with a progress of said television broadcast; and
a second display section displaying the information obtained by said Web-page-information-obtaining section in a second display area on said display device in synchronization with the progress of the television broadcast.

2. A Web page display apparatus comprising:
an image-receiving section receiving an image signal representing image of a television broadcast;
a character recognition section analyzing the image represented by the image signal received by said image receiving section to recognize a character string contained in said image;
a Web-page-information-obtaining section triggered by recognition of a location character string by said character recognition section to access a Web page the location of which is indicated by the location character string to obtain information provided by said Web page in synchronization with a progress of said television broadcast if the character string recognized by said character recognition section is the location character string indicating the location of the Web page on the Internet; and
a display section displaying the information obtained by said Web-page-information-obtaining section in synchronization with the progress of said television broadcast.

3. The Web page display apparatus according to claim 2, further comprising a search section for searching the Internet for a Web page based on a character string recognized by said character recognition section,
wherein if said Web page is found by said search section, said Web-page-information-obtaining section is triggered by the finding of said Web page to accesses said Web page to obtain information provided by said Web page in synchronization with the progress of said television broadcast.

4. A Web page display apparatus comprising:
a sound-receiving section receiving a sound signal representing sound of a television broadcast;
a speech recognition section analyzing the sound represented by the sound signal received by said sound receiving section to recognize a word contained in said sound;
a Web-page-information-obtaining section for accessing a Web page a location of which is indicated by a location word to obtain information provided by said Web page in synchronization with a progress of said television broadcast if the word recognized by said speech recognition section is the location word indicating the location of the Web page on the Internet, said access being triggered by the recognition of said location word; and
a display section displaying the information obtained by said Web-page-information-obtaining section in synchronization with the progress of said television broadcast.

5. The Web page display apparatus according to claim 4, further comprising a search section for searching the Internet for a Web page based on a word recognized by said speech recognition section,
wherein if the Web page is found by said search section, said Web-page-information-obtaining section is triggered by the finding of said Web page to access said Web page to obtain information provided by said Web page in synchronization with the progress of said television broadcast.
